(19) United States
(12) Patent Application Publication
(10) Pub. No.: US 2016/0333569 A1
(43) Pub. Date: Nov. 17, 2016

(54) MOBILE HOME CARE UNIT

(71) Applicant: Stephen A. Johnston, Mount Pleasant, SC (US)

(72) Inventor: Stephen A. Johnston, Mount Pleasant, SC (US)

(21) Appl. No.: 15/151,968

(22) Filed: May 11, 2016

Related U.S. Application Data
(60) Provisional application No. 62/159,549, filed on May 11, 2015.

(51) Int. Cl. E04B 1/348; E04H 1/12; E04H 1/00; A61G 10/02; E04B 1/343

(52) U.S. Cl. CPC E04B 1/34861; A61G 10/02; E04B 1/34336; E04B 1/34869; E04H 1/005; E04H 1/1205; E04B 2001/34892

(57) ABSTRACT

Modular or temporary healthcare building units are provided that interconnect with a patient's home. In one embodiment, one of the modular or temporary units includes a fully-equipped ADA-compliant bathroom. In another embodiment, the modular or temporary unit is referred to as a flex unit and typically accommodates a hospital bed and other associated support structures and features for housing and accommodating a patient that is in a stage of recovery or rehabilitation or, in some cases, the flex unit is used for end-of-life care.

### CROSS-REFERENCE TO RELATED APPLICATION

This application claims priority under 35 U.S.C. §119(e) from the following U.S. provisional application: Application Ser. No. 62/159549 filed on May 11, 2015. That application is incorporated in its entirety by reference herein.

### FIELD OF THE INVENTION

The present invention relates to healthcare facilities, and more particularly to mobile or temporary home care units.

### BACKGROUND OF THE INVENTION

It is common practice in the United States and other parts of the world to place patients in recovery or rehabilitation facilities after the patient has been treated in a hospital. An examination of this practice reveals that, in many instances, the health and well-being of the patient is not served. Indeed, this practice burdens healthcare systems and results in a costly and inefficient approach to recovery, rehabilitation and other types of care that are traditionally provided outside of conventional hospitals.

The shortcomings of traditional recovery and rehabilitation facilities are many. First and foremost, is the negative impact on the patient being away from home for extended periods. Benefits from the comfort and security of being in a home setting cannot be overstated. To be sure, being situated in a familiar home setting, in the company of family, is often powerful therapy that can deliver results unattainable by traditional healthcare, even care delivered by competent and caring healthcare professionals. Benefits associated with a patient recovering or rehabilitating in his or her home is lost in traditional recovery and rehabilitation facilities.

Aside from the patient being away from home for extended periods, there are other problems and drawbacks with traditional recovery and rehabilitation regimes. First, there is the length of stay. Some stays in hospitals and recovery and rehabilitation facilities are too long. That is, the patient stay is extended beyond what is needed or necessary. This obviously drives up costs and, in the end, causes health insurance premiums to escalate all to the detriment of the public at large. This undesirable result is often fueled by private providers that are incentivized to keep patients longer than is required. Then, on the other hand, there are situations where there is pressure to free up beds, resulting in the patient being discharged before recovery or rehabilitation is complete. In these cases, the patient is sent home but yet the home is not equipped to serve the patient and continue the recovery or rehabilitation process. This is often detrimental to the patient, causing relapses and this in turn causes the patient to have to be re-admitted to the hospital. In the end, this also drives up costs while not properly serving the patient and having the effect of increasing healthcare costs for the public-at-large.

Another problem with recovery and rehabilitation practices today is that, in many cases, there is insufficient capacity to serve the patients that are in need. In other words, there is an admissions backlog to healthcare facilities that are used for recovery and rehabilitation. The natural consequence of this is that some patients are required to extend their stays in hospitals. This again drives up costs. However, the important point and the major problem here is that hospitals are not equipped to provide proper recovery or rehabilitation care. Thus, the patient's needs are not addressed. Moreover, families and providers find waiting for space to free up in traditional recovery and rehabilitation facilities frustrating. This is not an insignificant problem because, in the end, it impacts many patients who are in need of immediate care but because of a shortage of beds within a reasonable area are unable to obtain the care needed.

The potential for patients acquiring infections in healthcare facilities is well documented. This not only applies to hospitals, but it also applies to recovery and rehabilitation facilities. Indeed, it is difficult to prevent these infections in institutional settings, especially large ones that include many patients and many healthcare professionals. It, therefore, is clear that infection rates can be reduced by reducing the overall size of the facilities and reducing the contact between patients and many healthcare staff and professionals.

All of these factors negatively impact the patient and the care being received. Not only are costs driven up which sometimes makes reasonable healthcare unaffordable for some but there is a continuing emotional impact on patients and their families. Traditional approaches to recovery and rehabilitation are not conducive to family support which in many instances can be the difference between a speedy and effective recovery and a poor or no recovery at all. To be sure, in the end, it is the patient that suffers the most.

All of this points to a need to reform healthcare practices and protocols relating to recovery and rehabilitation and other non-hospitalization services. There is and continues to be a need for increasing discharge rates relative to recovery and rehabilitating patients without compromising the quality and effectiveness of the healthcare. There is also a need for better bed management. That is, there is a need for getting patients timely admitted. Related to this is the need to speed up diagnoses, testing and ultimately the treatment of the patient. There is ample room to improve the overall care and quality of treatment of patients that are in need of recovery and rehabilitation care. This will improve patient satisfaction.

All of this underscores a severe need for a system for recovery and rehabilitation that avoids undue cost. In this regard, there is a need for protocols and policies for recovery and rehabilitation that can adhere to a reasonable budget and where cost can be easily and accurately tracked, and where there is transparency that enables financial accountability. Such a system and an approach to recovery and rehabilitation healthcare services will avoid bureaucracy and red tape and will, in the end, provide timely and high quality care for patients in need.

These problems, drawbacks and shortcomings in the area of recovery and rehabilitation healthcare point to the need for a different approach to serving patients that are in need of recovery and rehabilitation care. Indeed, a close examination of traditional healthcare in these areas suggests that there is a need to redirect the direction of recovery and rehabilitation care towards the patient's home. The overall well-being of patients will be served by placing recovery and rehabilitation care in a home setting where the patient will have the support of his or her family, the church, and the overall community in general.

### SUMMARY OF THE PRESENT INVENTION

The present invention addresses this problem in a practical, feasible and cost-effective manner. The system and process utilized and described herein transforms the patient's home to a facility where recovery and rehabilitation or even hospice care can be provided. This is achieved without turning the patient's home into a healthcare institution or to a structure that resembles a healthcare facility. As discussed below, the present invention provides home care modules or units that connect to the home and which provide the support and facilities required for efficient and effective recovery and rehabilitation, and in certain cases can provide a comfortable facility for end-of-life care. These healthcare facilities are both mobile and temporary, and as such can be quickly and easily employed and deployed without any significant inconvenience to the patient and his or her family. These healthcare modules or units blend into the home and simply become an extension of the home. These modules can accommodate various equipment, and even specialized equipment, to meet the needs of the intended patient. In some cases, the present invention provides two or more modules that are connected together and which are in turn, as a group, connected to the patient's home. As discussed below, these healthcare modules or units can be completely erected and can become operational within a matter of hours. When installed, these units provide adequate space, not only for the patient but for caregivers, healthcare staff and professionals, and family.

### BRIEF DESCRIPTION OF THE DRAWINGS

FIG. 1 is a perspective view showing a bathroom pod operatively connected to a patient's home through an adjustable corridor module.

FIG. 2 is a top plan view showing the bathroom pod and the corridor module for connecting the bathroom pod to the home.

FIG. 3 is a side elevational view of the bathroom pod with one wall removed to better illustrate the interior of the bathroom pod.

FIG. 4 is another side elevation view of a bathroom pod, as well as the corridor module again with a side portion of the bathroom module removed to better illustrate the interior thereof.

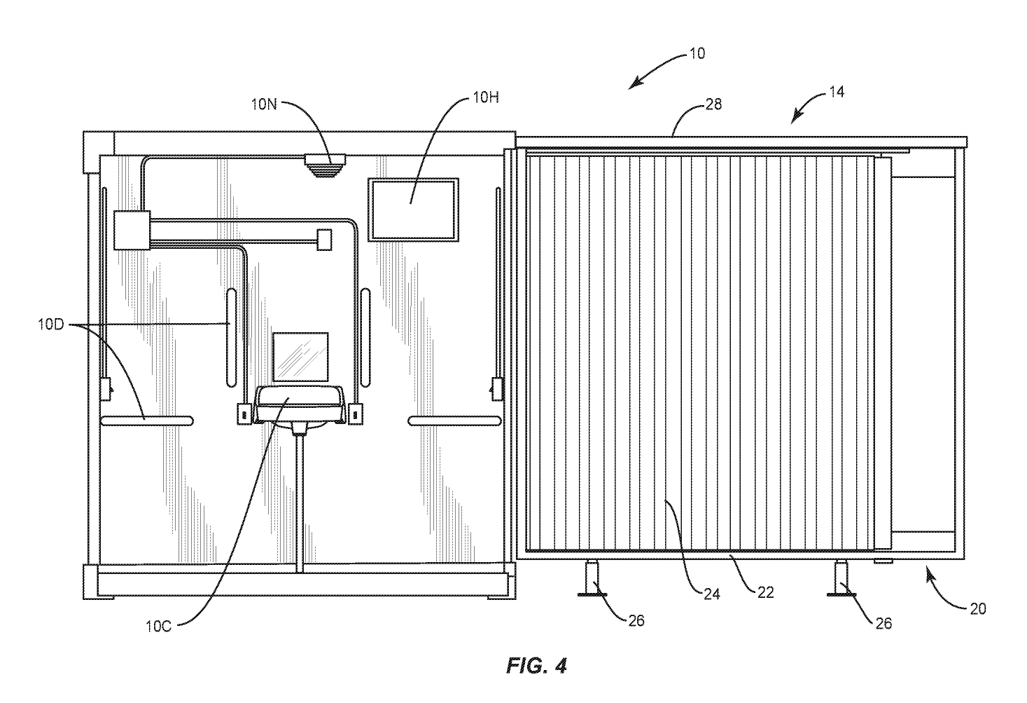

FIG. 5 is a top plan view of a flex room pod along with the corridor module.

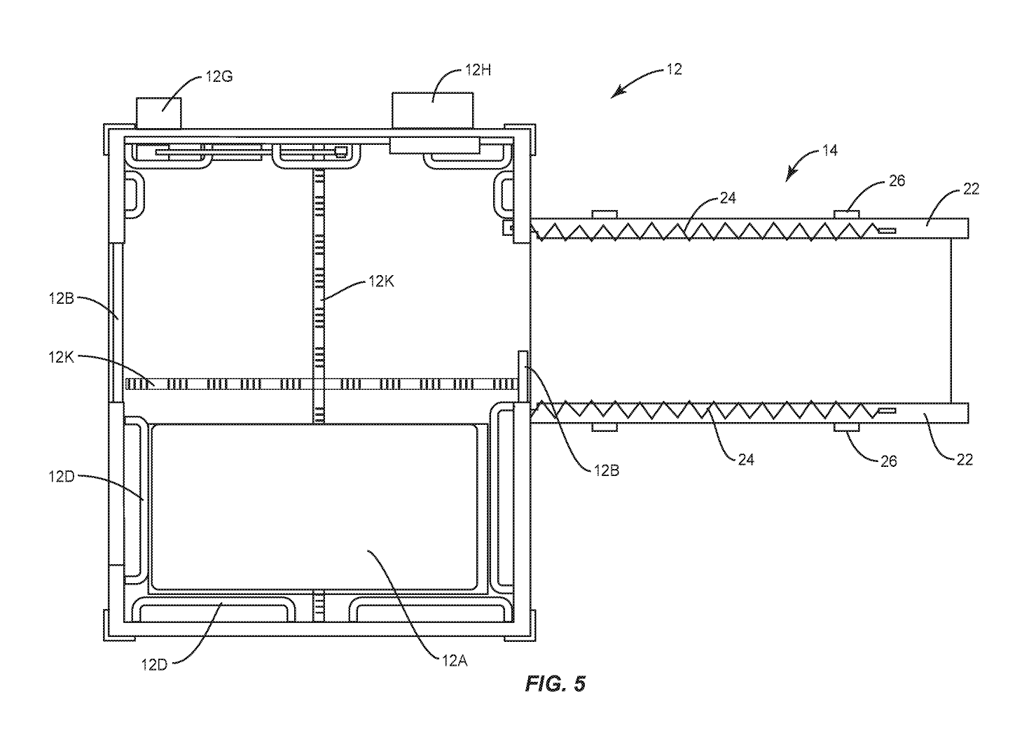

FIG. 6 is a plan view showing the bathroom pod and the flex room pod interconnected, as well as the corridor module connected between the bathroom pod and the home.

### DESCRIPTION OF EXEMPLARY EMBODIMENTS OF THE INVENTION

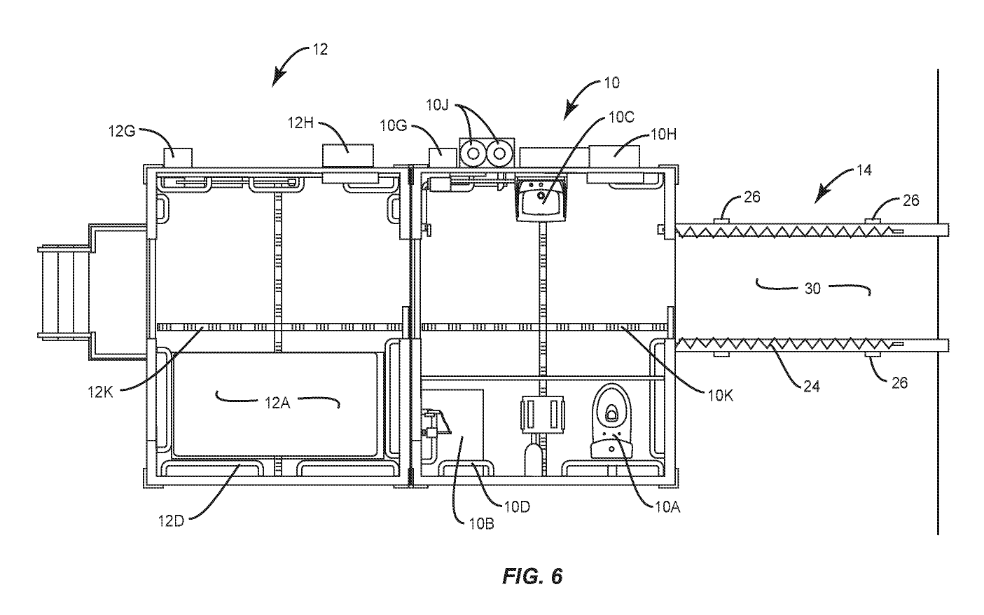

With further reference to the drawings, the present invention entails two modules or pods. One pod is referred to as a bathroom pod and indicated generally by the numeral 10. The second pod, as discussed above, is referred to as a flex room pod and is referred to generally by the numeral 12. The flex room pod 12, as discussed below, can be equipped in various ways. In one embodiment, the flex room pod 12 can accommodate a hospital bed 12A with various medical equipment connections. As discussed in more detail, the flex room pod 12 can serve various needs, such as a recovery room or rehabilitation room or a combination of both, or can be used for end-of-life care. Bathroom pod 12 can be used alone or can be employed as shown in FIG. 6 with a flex room pod 12. In some cases, the flex room pod 12 can be employed alone.

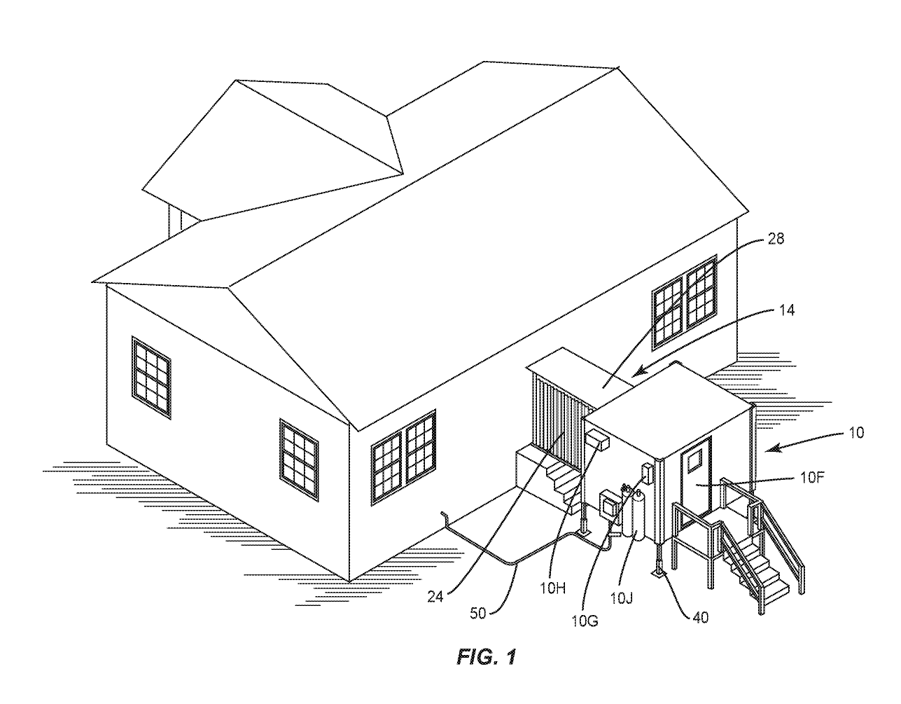

Before addressing the bathroom pod 10 and the flex room pod 12 in more detail, it will be beneficial to review the basic common structure and characteristics of each. At the outset, both units 10 and 12 are fully compliant with the American Disabilities Act (ADA). It should be pointed out that there are no exceptions in a preferred embodiment of the present invention. That is, every feature or component that is covered by the ADA is designed and built to be compliant with the ADA. Both units are designed such that they can be connected to a home that is built on a slab or includes a crawl space. That means that the elevation or height of these units can be adjusted during installation so as to provide a level or near level transition between the units and the home. Each unit includes a series of adjustable legs that enable the units to be adjusted with respect to a door and its opening of the patient's home. See FIG. 1, for example. In order to connect one of the units to the patient's home, there is provided an accordion transition module 14 or a temporary wall structure that is designed to extend from a door in the pod to a door formed in the patient's home. The accordion transition module 14 is designed to be adjustable and, in one embodiment of the present invention, can be adjusted between transition lengths of eight inches to eight feet. This means that the accordion transition module 14 will have an adjustable sidewall, roof and floor structure. That is, the sidewalls can retract and expand in a secure track extending between the pod and the patient's home. Likewise, the overhead roof can be accordion-type or can be any other conventional structure that is compatible with the sidewalls. This means that the accordion transition module 14 is enclosed and secure such that, as the patient and others transition between the home and one or more of the pods, there is a feeling of securement, and that the accordion transition module is nothing more than a convenient extension of the home. As briefly alluded to before, the pods 10 and 12 can be connected together. See FIG. 6. Various structural designs can be employed to enable this connection. In one embodiment, T-plates are employed to connect the two units together.

The size and construction of the pod 10 and 12 can vary. In one embodiment, the pods are of a steel construction for strength and durability and this allows the pods to be transported from one home to another home. These pods may comprise steel containers. In one preferred embodiment, the pods are 8′×10′.

Both pods 10 and 12 are designed to be connected to the existing utilities at the patient's home. Therefore, each pod is provided with interface connections for connecting to the water, sewer and electricity at the patient's home. In certain cases, it may be required to provide a temporary power pole for the one or more pods erected at a patient's home. In cases where the patient's hot water heater is inadequate to supply hot water to the pods, the units can be provided with their own hot water heaters, such as an LP gas instant hot water heater. In both cases, the pods 10 and 12 are provided with a back opening or a back door such as a sliding pocket door. An ADA ramp or stairs can be situated at a back disposed door for convenient egress and ingress.

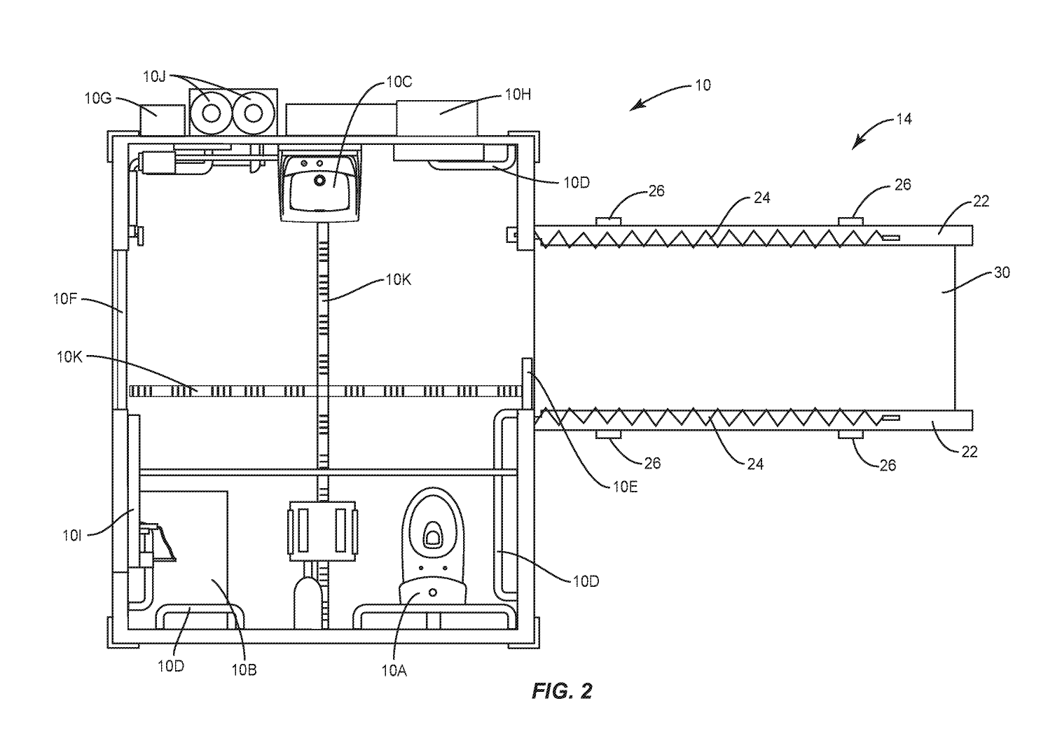

It is appreciated that the structure and the specific components of the bathroom pod 12 can vary. In any event, the bathroom pod 12 includes walls, a ceiling and a floor. The bathroom pod further includes a high profile toilet 10A. It also includes a shower 10B that is a non-threshold, roll-in shower. Shower 10B includes a fold-down bench, shelving, shower curtain, towel bar or rack. In addition, the bathroom suite 10 includes a lavatory or sink 10C with associated shelving for storing various items. There are also grab bars 10D formed at various locations along the walls of the bathroom suite 10. Further, there is a mirror located above the lavatory. In some bathroom suites, there can be provided a water filter for filtering and purifying water being directed into the bathroom suite. As seen in FIG. 2, there is shown a panel box 10G which functions as an electrical interface with the electricity being supplied to the bathroom suite. Various openings are provided in the wall structure of the bathroom suite 10 in order to accommodate doors and other structures. For example, there is an opening that accommodates a heating and air conditioning unit 10H. See FIG. 2. In a preferred embodiment, the air conditioning and heating unit 10H is remotely controlled. There is also provided, in the embodiment shown in the drawings, two sliding pocket doors 10E and 10F. As seen in the drawings, pocket door 10E is disposed adjacent the accordion transition structure 14 while pocket door 10F constitutes a back door.

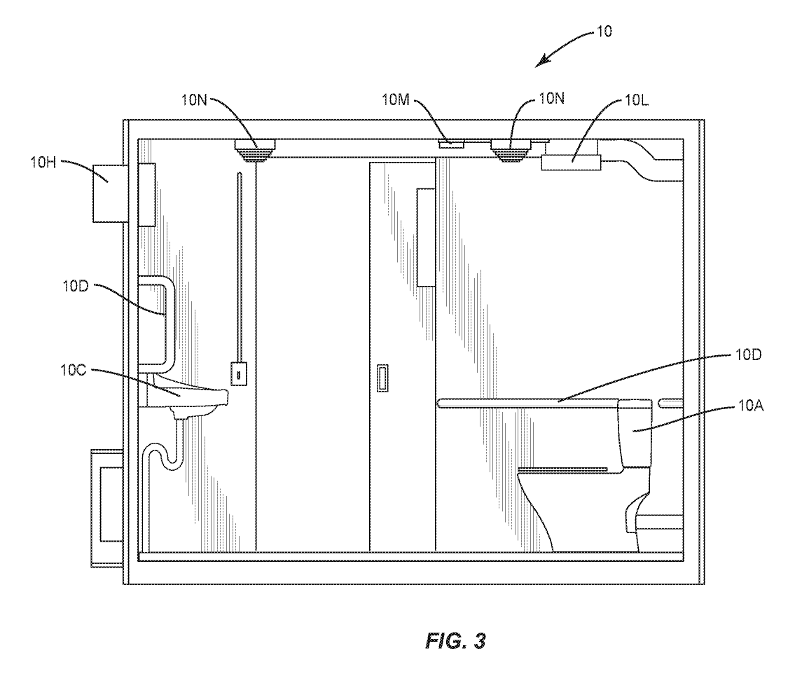

The bathroom pod 10 includes a number of other features. For example, there is a transfer bench 101 that is disposed adjacent the shower 10B that enables a person to be easily transferred from a wheelchair to the shower. In addition, disposed adjacent an exterior wall is a pair of gas tanks 10J that can be used to power an instant hot water heater or other gas consuming equipment or appliances. Also note in FIG. 2 where there is a pair of drain strips 10K formed across the floor of the bathroom pod 10. As seen in FIG. 3, the bathroom pod 10 can also include an exhaust vent 10L, smoke detector 10M and a series of lights 10N. It is important that the bathroom pod 10 be sufficiently spacious to accommodate a wheelchair.

Now turning to the flex room pod 12, it is first pointed out that the basic structure of the flex unit 12 is similar to that of the bathroom pod 10. That is, the flex pod includes a surrounding wall structure, flooring, a ceiling, as well as an exhaust fan, smoke alarm and energy efficient lighting. As with the bathroom pod 10, the flex room pod 12 includes sliding pocket doors 12B. Flex pod 12 can accommodate an ADA-compliant hospital bed 12A. The flex pod 12 also includes grab bars 120. In addition, the flex pod 12 can accommodate a patient lift mechanism for lifting and moving the patient about the flex pod. In addition, the flex pod 12 can accommodate cabinets and shelving to store clothes, linens, health supplies, etc.

In some cases, the flex pod 12 can accommodate medical equipment and even specialized medical equipment. Some medical equipment may require special connections and the flex pod 12 includes connection interfaces for a range of specialized medical equipment. It is appreciated that some patients have different and specialized needs when it comes to treatment. Flex pods 12 can accommodate and be configured to support the necessary structure and equipment to meet the needs of a range of patients.

As noted above, the flex room pod 12 is similar in many respects to the bathroom pod 12. For example, it includes pocket doors 12B, grab bars 12D, an electrical panel box 12G, an HVAC unit 12H and drain strips 12K in the floor.

Although the present disclosure has discussed recovery and rehabilitation, it should be pointed out that these are very broad terms that cover a wide range of healthcare services. It is also pointed out that the flex pod 12, as well as the bathroom pod 10, can be used in other circumstances that are not recovery or rehabilitation. For example, these units can accommodate hospice care and other end-of-life care.

Now with reference to the accordion transition module 14, it is noted that sometimes this structure is referred to as a corridor module. This is because the corridor module 14 is designed to be interconnected between either pod 10 or 12 and the patient's home. Viewing the corridor module 14, it is seen that the same includes a basic frame structure indicated generally by the numeral 20. The frame structure will support the floor, sidewalls and roof of a corridor module 14. In particular, the frame structure includes a pair of lower longitudinal tracks 22. These tracks form a part of the lower portion of the overall frame structure. The frame structure further includes a series of adjustable legs 26. These adjustable legs 26 enable the corridor module 14 to be adjusted height-wise in order to make a smooth or orderly transition from one of the pods to the patient's home. Disposed in the tracks 22 is a pair of adjustable accordion walls 24. These accordion walls 24 can be extended and retracted so as to adjust the length of the sidewalls of the corridor module 14. In addition, the corridor module 14 includes a roof 28 and a floor or ramp structure 30.

Returning to the pods 10 and 12, it is appreciated that these pods, along with the corridor module 14, are designed to be temporary, non-permanent structures. The pods 10 or 12 are each provided with a series of adjustable legs or supports 40. These legs 40 allow the pods 10 and 12 to be adjusted to an appropriate height. This accommodates variations in elevations next to the door of the patient's home. This enables the floor of the pods and the floor or ramp 30 of the corridor module to be level or substantially level so that it is easy for the patient to move from the pods through the corridor module 14 and into the home.

With reference to FIG. 1, it is seen where a bathroom pod 10 and corridor module 14 is connected to a patient's home. Note that the adjustable legs 40 associated with the bathroom pod 10 have been adjusted such that the floor of the bathroom pod and the floor or ramp of the corridor module 14 provide a generally level condition. Note the water line 50 extending from the patient's home to the water inlet interface of the bathroom pod 10. The water line 50 supplies all of the water required by the bathroom pod 10. The bathroom pod 10 would also be connected to the sewer system or the septic tank system of the home. That is not particularly shown but would be provided.

### Installing and Implementing the Bathroom Pod and Flex Room Pod of the Present Invention

Prior to installing the pods 10 and 12 at a patient's home, a visual site survey and visit is made to the home to determine the appropriate location of the unit or units with respect to the patient's home. Under most circumstances, the unit or units can be installed at the patient's home within days of the initial visit. After the units have been installed, a walkthrough is made with the patient and the patient's family. Once the patient has recovered or the rehabilitation period is over or there is no longer a use for the unit or units, they are removed.

When the pods are delivered to the patient's home, they are set in place, leveled and then secured in place with anchor straps on all four sides or as needed. As a general rule, at least one of the units is set within inches or up to eight feet of the door to the home, typically the rear door to the patient's home. Devices that are commonly referred to as lock-in-tracks are attached around the exterior of the home door area to accept the accordion transition module 14. The exterior door of the home is still in place and operable to offer additional security. The accordion transition module locks in place around the exterior of the door to the home, connecting the adjacent pod to the home in a secure manner. The accordion transition module 14 is interconnected to the home and locked in place. It will be appreciated by those skilled in the art that other types of construction can be employed to form the transition structure between the pods and the patient's home. The reference to an accordion transition structure is simply one example of a structure that could be used as a transition between the units and the patient's home. Further, the utilities are connected and tested to insure that all utilities properly work. It is preferable that no or substantially no building activity occurs at the site. The pods 10 and 12 are designed to be independent and temporary connections made to the patient's home.

Set forth below is a list of objectives and advantages of the pods 10 and 12 of a preferred design. This is not to be considered limitations on any inventions disclosed herein but merely describes characteristics, some of which may be included in a preferred design.
Creates temporary on demand, multi-functional Health Care Space at patients home; this is not a permanent structure of permanent connection to patient's home.
Creates a new untapped availability of health care beds/facilities in the Health Care Industry
Pods temporarily connect to patients home to prove space/facility for In—Home care
Frees up staff and resources for hospitals and long and short term care facilities
Reduces health care cost for (1) Provides; both public and private, (2) Insures; both public and private and (3) patients and their families without the costly capital expenditures and limitations of traditional health care facilities
Creates and provides flexible heath care facility/space for In-Home Health Care: (1) Home care, (2) Home medical care, (3) Hospice care, (4) Recovery and/or (5) Rehab/therapy
Keeps patients and families together in their home during sickness, recover, rehab, home care, home medical care and/or end of life hospice care
Allows hospitals to discharge patients to their home who otherwise could not be discharged to their home
Alternative to long hospital stay or long stay in a Long/Short term care facility
Frees up hospital beds/space and resources; improves hospital bed management which allows hospitals to care for more patients and reduce wait time to enter hospital to admit, diagnose and treat more patients
Reduces LOS (Length of Stay) in hospitals
Fees up Long and Short term health care facilities beds/space and resources; allows patients to stay home longer with the support of family, friends, community and church
Reduce HAI (Health Associated Infections) sickness/death and associated cost
Reduce Re-admissions of patients and associated cost
Helps improve QOC (Quality of Care) and LOC (Level of Care) and patient satisfaction
Provides space for some patients ADL's (Activities of Daily Living)
Provides patients at end of life (hospices care) to be at home with family and loved ones which allows for more quantity and quality of time patients can share with family and friends
Allows patients to stay home longer with family and loved ones which can help reduce abuse of vulnerable patients in an instructional facility
Provides the space needed at a patients home for either family in home care or for a paid care giver to provide care needed
Encourages family engagement in home care for patients verse costly intuitional facility—helps save money for patients or Insurers, both public or private
Provides greater support option to patients and family to maintain independence
Helps reduce family expense and time from traveling to local or distance traditional hospitals or long-short term care facilities
Helps family care givers keep employment by reducing time away from work to travel and care for a family member in a traditional health care facility compared to having patient in their home with in home care
Allows elderly or those with disabilities that cannot drive or travel to be with their loved one at home compared to loved one/patient being in a traditional health care facility located in or out of town
Reduce economic/financial impact of patients and their families
Supports health care trend of In-Home care
New approach to In—Home care options; expands and strengthens home based services as part of a full spectrum of care options
Expands access to home base options for care
Helps support creating new jobs in the In-Home Health Care industry
Supports and encourage family engagement in caregiving
New approach to providing long term care and support
Psychological and emotional of patient being at home with family compared to a health care institution
Designed to meet or exceed compliance for ADA
Designed for people/patients of all age groups
Designed to accommodate some In home medical equipment
Designed with additional Fall Prevention measures; additional grab bars, anti-slip floor, “wet floor” with drain system in floor and a transfer bench to mention a few
Designed with safety features (ex. Exit lights that operate for a limited time encase of a power outage, extra grab bars, anti-slip flooring, water filter system)
Custom designed “breezeway” that provides weather proof access from patients home to Pod—allows for walking, walker or wheelchair access
“Breezeway” corridor is secured to patients home via a “track system” that is attached around exterior of door and our “breezeway” corridor had interior locks that secures system in place
ADA ramp at patients door placed between patients home and pod for access, ramp is covered by custom breezeway—allows for walking, walker or wheelchair access
Pods can be placed with inches to approximately eight feet away from home
Pods can be temporarily place in rear of home, front of home, in some garages and carports
Pods do not have wheels, they are mobilized based via truck or trailer and moved in place with a fork lift, removal is same equipment
Pods have strap down connection to attach straps to assist in securing in place, if needed
Pods can be installed and remove at patients home without traditional construction/building activity, designed to be simple and quick temporarily installed and removed from patients home
Designed to be mobilized/transported/placed at patients home based on demand and need, transported via truck or trailer
Designed to accommodate patients home on a slab and crawl space
Designed to set on grade/ground level or “jacks” can be installed on pods to adjust height of pod to accommodate homes on crawl spaces
Pods designed to connect to patients utilities to supply electrical power, water and sewer for pod. In some cases, a temporary electrical pole with power may be needed. In rare cases, a holding tank could be used for sewer
Designed with exterior connection for electrical, water and sewer
Designed for relatively quick set up and removal from patients home
Designed to be energy efficient
Heating and Air Conditioning system
Electrical system—electrical outlets and switches are placed with ADA range
Interior lights, exterior lights, battery back up exit signs at both doors
Air circulation system
Floor Drain(s)
Designed for quick interior wash down and cleaning
Exterior siding
Doors on two sides of pods, doors have “windows”/glass in door to allow natural light and visibility
Doors have ADA handles
Designed to accommodate either stairs or ramp on exit side of pod
Bathroom pod has extra space to allow caregiver room to work with patients with or without a wheelchair
Bathroom pod has transfer bench in shower area
Bathroom pod as plumbing system with plumbing connection on exterior of pod
Bathroom pod as sewer system with sewer connection on exterior of pod
Bathroom pod had ADA faucets, sink, toilet, mirror
Bathroom pod has water filter system
Bathroom pod has instant hot water system to supply hot water for pod
Bathroom pod has LP gas tanks to supply LP gas to instant hot water system

From the foregoing specification and discussion, it is seen that the advantages discussed are all achieved by the present invention. The advantages discussed at the beginning will not be repeated here, but suffice it to say that this system and process enables the patient to receive speedy and efficient care in a home environment surrounded by his or her family and friends. The bureaucracy, red tape and the inefficiencies that are inherent in traditional recovery and rehabilitation facilities is avoided.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A pod system for enabling multi-functional healthcare space to be provided at a patient's home, comprising:
a. a home medical care system having at least two pods including a mobile bathroom pod and a mobile flex room pod, as well as a mobile modular corridor for connecting the pods to the home the patient;
b. the mobile bathroom pod including:
i. a floor, walls and a roof and including a toilet, shower and a sink;
ii. adjustable supports for engaging the ground or other support structure and for adjusting the height of the mobile pathroom pod with respect to the ground or other support structure;
iii. one or more drains formed in the floor;
iv. one or more access openings in at least one wall and a sliding pocket door for opening and closing the access opening; and
v. grab bars secured at various locations to the walls and accessible in the interior of the mobile bathroom pod;
c. the mobile flex room pod including:
i. a floor, walls and a roof that define the mobile flex room pod;
ii. one or more access openings formed in the walls and a sliding pocket door for opening and closing the access openings;
iii. grab bars secured at various locations to the walls and accessible interiorly of the mobile flex room pod;
iv. adjustable supports for engaging the ground or other supporting structure and for adjusting the height of the mobile flex room pod relative to the ground or the other support structure; and
v. one or more drains formed in the floor of the flex room pod;
d. an HVAC unit mounted to the wall of each pod for heating and cooling the respective pods;
e. the mobile corridor module including:
i. a frame structure;
ii. a floor or ramp supported in the frame structure;
iii. a roof supported by the frame structure;
iv. a pair of adjustable accordion sidewalls supported by the frame structure and forming sidewalls of the corridor module; and
v. the frame structure including a pair of tracks for receiving and supporting the adjustable accordion sidewalls and permitting the accordion sidewalls to be extended and retracted so as to effectively adjust the length of the mobile corridor module;
f. wherein the mobile bathroom pod and the mobile flex room pod are disposed in side-by-side relationship and where at least one access opening associated with the mobile bathroom pod and at least one access opening associated with a mobile flex room pod are aligned such that the patient can move back and forth between the two pods;
g. utility provisions associated with one or both of the pods and including:
i. an electrical panel mounted on at least one of the pods;
ii. a water inlet associated with at least one of the pods; and
iii. a water heater associated with at least one of the pods for heating incoming water; and
h. wherein the corridor module is operatively connected to one access opening of one of the pods and extends therefrom to an access opening associated with the home of the patient such that the patient can move between the home and the two pods.

2. The system of claim 1 further including one or more gas tanks secured adjacent one wall of one of the pods.

3. The system of claim 1 including a transfer bench mounted to an interior side of one wall of the bathroom pod and disposed adjacent the shower.

4. The system of claim 1 wherein the drains in the floors of the pods include a linear drain strip that extends across the floor of each of the pods.

5. A mobile healthcare system operative to connect to a patient's home for use in administering care to the patient, comprising:
a mobile and temporary bathroom pod including a floor, walls and a roof and including in the interior thereof a toilet, a shower and a sink;
a plurality of grab bars secured at various locations to an interior side of one or more walls of the pod;
an HVAC unit mounted in one wall of the pod for heating and cooling the pod;
utility connections mounted on at least one wall of the pod for enabling electrical power and water to be directed to the pod;
at least one access opening formed in one wall;
the pod supported by at least four adjustable legs that are operative to support the pod over the ground or over an underlying support surface and wherein the adjustable legs provide for the height of the pod to be adjusted with respect to the ground or the support surface;
a moveable and temporary corridor module for interconnecting the pod with the patient's home; and
the corridor module including a frame structure, a floor or ramp supported in the frame structure, a roof supported by the frame structure, and a pair of adjustable accordion sidewalls on opposed side of the corridor module and which can be extended and retracted; and
wherein the corridor module is configured to be connected between the patient's home and the pod such that the patient can move between the patient's home, the corridor and the pod.

6. The mobile healthcare space of claim 5 including an instant hot water heater mounted to the exterior side of one wall of the pod; and one or more strip drains provided in the floor of the pod.

7. A mobile healthcare system operative to be connected to a patient's home for use in administering care to the patient, comprising:
a mobile and temporary flex room pod including a floor, walls and roof and including grab bars secured to an interior side of one or more of the walls;
an HVAC unit mounted on one wall for heating and cooling the pod;
one or more utility connections mounted on at least one wall of the pod for providing electrical power to the pod;
a corridor module operative to be interconnected between the pod and the patient's home and wherein the corridor module is mobile and temporary and includes a frame structure and a floor and a roof, and wherein the corridor module includes a pair of accordion adjustable walls that can be extended and retracted in the frame structure of the corridor module; and
a series of adjustable legs for supporting the pod over the ground or other underlying support surface such that the height of the pod can be adjusted.

8. The system of claim 7 including a pair of drain strips formed in the floor of the pod; and wherein the pod includes one or more sliding pocket doors wherein at least one of the pocket doors is disposed adjacent the corridor module.
